(19) United States
(12) Patent Application Publication
(10) Pub. No.: US 2025/0132620 A1
(43) Pub. Date: Apr. 24, 2025

(54) METHOD FOR PRODUCING A COMPONENT OF AN ELECTRIC MACHINE, COMPONENT OF AN ELECTRIC MACHINE, AND ELECTRIC MOTOR IN AN AIRCRAFT PROPULSION SYSTEM INCLUDING A COMPONENT OF THIS TYPE

(71) Applicant: Rolls-Royce Deutschland Ltd & Co KG, Blankenfelde-Mahlow (DE)

(72) Inventors: Anton RUDENKO, Unterhaching (DE); Johannes Gabriel BAUER, Eching (DE)

(21) Appl. No.: 18/722,581

(22) PCT Filed: Dec. 13, 2022
(86) PCT No.: PCT/EP2022/085563

§ 371 Date: Jun. 20, 2024

(30) Foreign Application Priority Data
Dec. 21, 2021 (DE) 10 2021 134 000.4

(51) Int. Cl. H02K 1/278; H01F 13/00; H02K 1/02; H02K 15/035; H02K 15/121

(52) U.S. Cl. CPC H02K 1/278; H01F 13/003; H02K 1/02; H02K 15/035; H02K 15/121

(57) ABSTRACT

The invention relates to a method for producing a component (10) of an electric machine, wherein at least one permanent magnet means (1) of the component (10) is arranged on or at the component (10), together with at least one mechanical restraining means (2) for spatially fixing the at least one permanent magnet means (1), and the at least one mechanical restraining means (2) consists of a composite material or contains same, characterised in that, at least during a thermal treatment of the component (10), a means (3, F) is used for the targeted control of the magnetic field of the permanent magnet means (1).

This application is the National Stage of International Application No. PCT/EP2022/085563, filed Dec. 13, 2022, which claims the benefit of German Patent Application No. DE 10 2021 134 000.4, filed Dec. 21, 2021. The entire contents of these documents are hereby incorporated herein by reference.

### BACKGROUND

The present embodiments relate to a method, a component of an electric machine, and a motor in an aircraft propulsion system.

In electric machines (e.g., also in rotors of electric propulsion units of aircraft), use is frequently made of permanent magnet device(s) that are subjected to centrifugal forces, magnetic forces, and/or possibly other forces.

It is necessary to compensate for these forces and to fix the permanent magnet devices in their position. Restraints, such as wrappings on rotors that counteract the forces, are known for this purpose.

For reasons of efficiency, these restraints are to have a low electrical conductivity. Therefore, the restraints often have composite materials such as, for example, carbon fiber reinforced polymers.

In order that the restraints maintain their stability, however, the glass transition temperature of the polymer material is to lie sufficiently far above the operating temperatures of the electric machine. Above the glass transition temperature, a solid (e.g., also thermosetting) polymer changes to a rubber-like to semi-liquid state, in which the mechanical stability of the restraints would no longer be provided.

It is known that a restraint for permanent magnet devices is produced separately from the electric machine. This provides, for example, that the fiber composite material is wound and cured separately and is then attached to a rotor of the electric machine (e.g., by a shrinking process). During this process, the high production costs are disadvantageous, since the outlay on production apparatus is considerable. In addition, the production times are comparatively long. Further, the restraints are to be configured such that, for example, the restraints withstand the high mechanical loadings during the shrinking. Thus, the fibers of the fiber composite restraints are, for example, be placed where the fibers would not be necessary to achieve the actual restraining task. Thus, as a result of the design, the restraints will become heavier than would actually be necessary.

Alternatively, the fiber composite structure of the restraints may be produced directly on the rotor of the electric machine (“in-situ”) (e.g., the winding and curing of the composite material is carried out on the rotor). The entire rotor is subjected to the production cycle of the composite material, which provides that, for example, the rotor is heated in an oven or an autoclave in accordance with specific time specifications. The glass transition temperature of the composite material represents a limitation on the production process.

The higher the curing temperature of the composite material, the higher the thermal stability of the component so that, in principle, higher temperatures would be provided. However, since the curing of the restraints is carried out directly on the rotor, comparatively high temperatures are present. The consequence is that under certain circumstances, the permanent magnet devices may be permanently de-magnetized, since de-magnetization begins above the Curie temperature. Materials are basically usable as magnetic materials only considerably below the Curie temperature.

Because of these contradictory requirements, it is difficult to find an adequate safety margin between the operating temperatures or curing temperatures and the glass transition temperature. For applications in air and space travel, this safety margin should be at least 28° C., according to the Composite Materials Handbook 17.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, production of permanent magnetic components of an electric machine without demagnetization of permanent magnet devices is provided.

At least one permanent magnet device of a component is arranged on or at the component, together with at least one mechanical restraining device (e.g., a mechanical restraint) for spatially fixing the at least one permanent magnet device. The at least one mechanical restraining device consists of a composite material or contains composite material. This corresponds to the attachment of the restraining device in-situ. At least during a thermal treatment of the component, a way (e.g., means; a device) for targeted control of the magnetic field of the permanent magnet device is used. This specifically influences the permanent magnet device in order that the permanent magnet device does not demagnetize. As will become clear below, the way may be a further mechanical device or a further method act.

In one embodiment, before, during, or after the attachment of the at least one permanent magnet device and the at least one mechanical restraining device, at least one magnetic shunt is arranged on or at the component, so that this interacts magnetically with the at least one permanent magnet device. This interaction is, for example, magnetic shielding of the permanent magnet device to prevent demagnetization.

The at least one permanent magnet device, the at least one mechanical restraining device, and the at least one magnetic shunt may then be subjected to a thermal treatment for curing the restraining device. The at least one magnetic shunt may then be removed before a further use of the component.

In a further embodiment, after the attachment of the at least one permanent magnet device and the at least one mechanical restraining device to the component (e.g., during a thermal treatment), a magnetic field is applied to the component. Both the magnetic field strength and the induction are positive. The use of such an opposing field is likewise used to prevent undesired magnetization. If an embodiment with a radial magnetic flux of the permanent device is assumed, then a magnetic coil device analogous to a stator with a non-rotating field may be used.

In both methods, the properties of the permanent magnet device are influenced in a targeted manner in order to permit higher curing temperatures.

The two methods may also be applied in combination. The elements for the magnetic short-circuit of the one method and for the external electric field would be connected magnetically in series and reinforce one another in the action on the magnetic material.

In one embodiment, the at least one magnetic shunt includes soft magnetic material or consists of this material. Soft magnetic materials may be distinguished roughly from other materials by their coercivity field strength. Materials with a low coercivity field strength (e.g. less than 10 A/m) are designated as soft magnetic. Thus, for example, electric sheet steels having an iron-silicon alloy, a cobalt-iron alloy, and/or a nickel-iron alloy may be used as soft magnetic materials. The soft magnetic material may be used in a flat or powder form. Effective magnetic relief of the load on the rotor permanent magnet may also be carried out by external magnetic material with a higher temperature class (e.g., samarium cobalt magnetic material).

The at least one magnetic shunt may be configured, for example, as a ring or cylindrical component and be arranged concentrically around the at least one permanent magnet device. Such a design is useful when the magnetic flux is present in the radial direction.

The thermal treatment of the at least one restraining device may be carried out at least at more than 140° C., so that relatively high temperatures may be realized. The thermal treatment may also be carried out at 5 to 10° C. below the glass transition temperature or the smallest value of a glass transition range of the least one mechanical restraining device.

At least one permanent magnet device is provided on or at the component of an electric machine, together with at least one mechanical restraining device for spatially fixing the at least one permanent magnet device, and the at least one restraining device consists of a composite material or contains composite material. At least one magnetic shunt is arranged on or at the component such that the at least one magnetic shunt interacts magnetically with the at least one permanent magnet device. Therefore, during a thermal treatment, this component is protected against demagnetization on account of the relatively high temperatures that are applied. The component may be configured, for example, as a rotor of an electric motor.

In one embodiment, the at least one magnetic shunt is configured as a ring or cylindrical component that is arranged concentrically around the at least one permanent magnet device. The at least one magnetic shunt includes soft magnetic material, for example, or consists of this material.

The soft magnetic material may be, for example, an electric sheet steel having an iron-silicon alloy, a cobalt-iron alloy, and/or a nickel-iron alloy.

An electric motor in an aircraft propulsion system may, for example, have a motor with a component that may be produced according to at least one method of the present embodiments.

### BRIEF DESCRIPTION OF THE DRAWINGS

FIG. 1 shows a schematic partial view of an embodiment of a component;

FIG. 2 shows a flowchart of one embodiment of a method;

FIG. 3 shows a further embodiment of a method; and

FIG. 4 shows a schematic illustration of a connection between induction and magnetic field strength.

### DETAILED DESCRIPTION

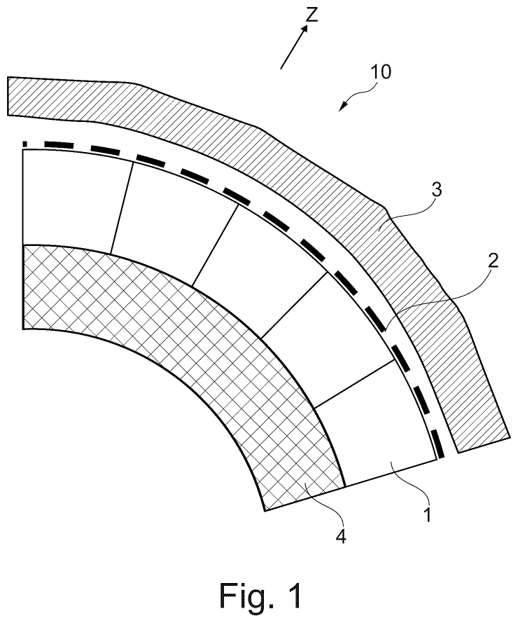

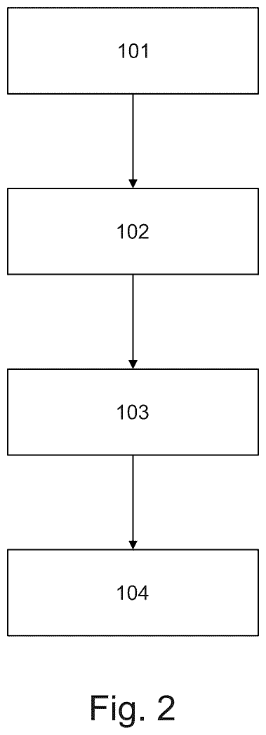

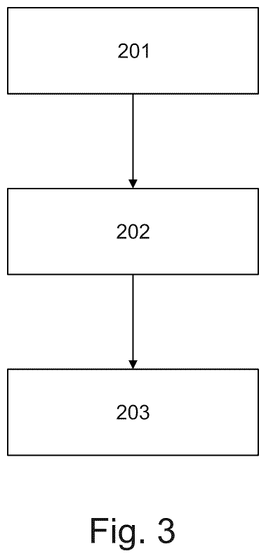

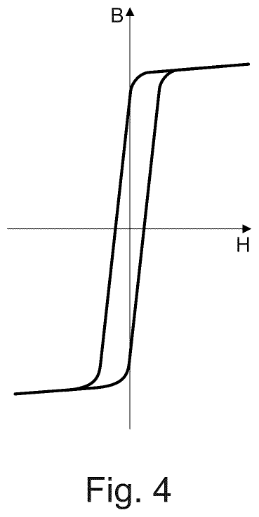

In the following text, embodiments in which, at least during a thermal treatment of a component of an electric machine, a way (e.g., a device) for the targeted control of the magnetic field from permanent magnet devices is used in order to avoid de-magnetization. In the embodiment according to FIG. 1 and FIG. 2, a mechanical device in the form of a magnetic shunt 3 is used. In FIGS. 3 and 4, the way is a further method act, in which a specific magnetic field is used.

In FIG. 1, a part of the rotor 10 of an electric motor that, for example, may be used in an aircraft propulsion unit is illustrated in a schematic section. In the illustration in FIG. 1, the section is perpendicular to the axis of rotation.

By using this component 10, an embodiment will be explained, with, in principle, other embodiments and areas of application also being possible.

Permanent magnet devices 1 are arranged in a manner known on an outer periphery of a shaft 4 of the rotor 10. The permanent magnet devices 1 may include hard magnetic iron, cobalt, and/or nickel alloys. In the schematic illustration of FIG. 1, polarities of the permanent magnet devices 1 are not illustrated. In addition, a gap-free arrangement of the permanent magnet devices 1 illustrated in FIG. 1 is provided as an example.

In operation, the permanent magnet devices 1 experience, amongst other things, centrifugal forces Z that act radially outward.

In order that the permanent magnet devices 1 change their position as little as possible or even not at all, a mechanical restraining device 2 that, for example, surrounds the permanent magnet devices 2 concentrically (e.g., a circularly cylindrical wrapper is formed around the permanent magnet devices 1) is provided.

This mechanical restraining device 2 (also designated as a bandage) may consist of a fiber composite material, for example, or include the lathe fiber composite material. The mechanical restraining device 2 has a proportion of polymer material. In the embodiment illustrated in FIG. 1, the mechanical restraining device 2 is attached directly to the component 10 (e.g., wound). Curing of the mechanical restraining device 2 is carried out in-situ (e.g., on the component).

In order that the relatively high temperatures (e.g., above 140° C.) arising during the curing do not lead to undesired de-magnetization of the permanent magnet devices 1, a magnetic shunt 3 is likewise arranged concentrically around the permanent magnet devices 1. The magnetic shunt 3 is configured for radial magnetic flux that is present here. In other applications with other component geometries, the magnetic shunt 3 will also assume other forms.

The magnetic shunt 3 includes soft magnetic material or consists of soft magnetic material. For example, electric sheet steels or soft magnetic alloys may be used.

The magnetic shunt 3 forms a magnetic short-circuit by connecting regions with opposite magnetic polarities to one another. Therefore, magnetic field lines are deflected in a desired manner, so that, in the embodiment illustrated, it is not possible for demagnetization of the permanent magnet devices 1 to occur if the component 10 is provided with the mechanical restraining device 2 in-situ.

A corresponding method for producing the component is described in FIG. 2.

In a first act 101, one or more permanent magnet devices 1 are provided. The arrangement of the concentric mechanical restraining device 2 is then carried out in act 102. In the following act, the magnetic shunt 3 is then attached, so that a thermal treatment of the component 10 for curing may then be carried out in act 104.

The thermal treatment 104 may be carried out at 5 to 10° C. below a glass transition temperature or a smallest value of a glass transition range of the mechanical restraining device 2.

A further method for producing a component of an electric machine, which is based on the same basic formation, is illustrated in conjunction with FIG. 3.

In a first act 201, the magnetic permanent magnet device 1 is provided. The arrangement of the restraining device 2, concentric, for example, is carried out in act 202. Then, for example, during the thermal treatment for curing the mechanical restraining device, in act 202 a magnetic field F is applied to the component 10 as an opposing field (e.g., with a braking effect) in the first quadrant of the B-H diagram (see FIG. 4), so that both the magnetic field strength H and the induction B are positive (see FIG. 4). By reason of this targeted magnetic influence on the magnetic behavior, a braking action is achieved.

An example of a hysteresis curve of a soft magnetic material is reproduced in FIG. 4.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for producing a component of an electric machine, the method comprising:
arranging at least one permanent magnet device of the component on or at the component, together with at least one mechanical restraining device for spatially fixing the at least one permanent magnet device, the at least one mechanical restraining device consisting of a composite material or containing the composite material; and
during a thermal treatment of the component, using a means for targeted control of a magnetic field of the at least one permanent magnet device.

2. The method of claim 1, further comprising:
before, during, or after the arranging of the at least one permanent magnet device and the at least one mechanical restraining device, arranging at least one magnetic shunt on or at the component, so that the at least one magnetic shunt interacts magnetically with the at least one permanent magnet device; and
subjecting the at least one permanent magnet device, the at least one mechanical restraining device, and the at least one magnetic shunt to a thermal treatment for curing the at least one mechanical restraining device.

3. The method of claim 1, further comprising applying a magnetic field to the component after the arranging of the at least one permanent magnet device and the at least one mechanical restraining device on or at the component,
wherein both a magnetic field strength and an induction are positive.

4. The method of claim 1, wherein the at least one magnetic shunt includes soft magnetic material or consists of the soft magnetic material.

5. The method of claim 4, wherein the soft magnetic material is an electric sheet steel having an iron-silicon alloy, a cobalt-iron alloy, a nickel-iron alloy, or any combination thereof.

6. The method of claim 4, wherein the soft magnetic material is used in a flat or powder form.

7. The method of claim 1, wherein the at least one magnetic shunt is configured as a ring or cylindrical component that is arranged concentrically around the at least one permanent magnet device.

8. The method a, wherein the thermal treatment is carried out at more than 140° C.

9. The method of claim 1, wherein the thermal treatment is carried out at 5 to 10° C. below a glass transition temperature or a smallest value of a glass transition range of the at least one mechanical restraining device.

10. A component of an electric machine, the component comprising:
at least one permanent magnet device; and
at least one mechanical restraining device configured for spatially fixing the at least one permanent magnet device, wherein the at least one permanent magnet device is arranged on or at the component together with the at last one mechanical restraining device, and wherein the at least one mechanical restraining device consists of a composite material or contains the composite material; and
at least one magnetic shunt arranged on or at the component, so that the at least one magnetic shunt interacts magnetically with the at least one permanent magnet device.

11. The component of claim 10, wherein the component is configured as a rotor of an electric motor.

12. The component of claim 10, wherein the at least one magnetic shunt is configured as a ring or cylindrical component that is arranged concentrically around the at least one permanent magnet device.

13. The component of claim 10, wherein the at least one magnetic shunt includes soft magnetic material or consists of the soft magnetic material.

14. The component of claim 13, wherein the soft magnetic material is an electric sheet steel having an iron-silicon alloy, a cobalt-iron alloy, a nickel-iron alloy, or any combination thereof.

15. An electric motor in an aircraft propulsion system, the electric motor comprising:
a component comprising:
at least one permanent magnet device; and
at least one mechanical restraining device configured for spatially fixing the at least one permanent magnet device, wherein the at least one permanent magnet device is arranged on or at the component together with the at last one mechanical restraining device, and wherein the at least one mechanical restraining device consists of a composite material or contains the composite material; and
at least one magnetic shunt arranged on or at the component, so that the at least one magnetic shunt interacts magnetically with the at least one permanent magnet device.
